(19) United States
(12) Patent Application Publication
(10) Pub. No.: US 2010/0112509 A1
(43) Pub. Date: May 6, 2010

(54) Light emitting device and driving device with a luminous diode

(76) Inventors: Dieter Werner, Leutkirch (DE); Karl Mack, Leutkirch (DE); Helmut Gruber, Buxheim (DE)

Correspondence Address: JACOBSON HOLMAN PLLC, 400 SEVENTH STREET N.W., SUITE 600, WASHINGTON, DC, 20004, US

(21) Appl. No.: 12/588,861

(22) Filed: Oct. 30, 2009

(30) Foreign Application Priority Data
Oct. 31, 2008 (DE) 10 2008 054 196.6

(51) Int. Cl. A61C 3/00

(52) U.S. Cl. 433/29

(57) ABSTRACT

A light emitting device for a drive of medical instruments and/or hand pieces contains a carrier device consisting of at least one first layer and at least one second layer; and a luminous diode arranged on a surface of the carrier device pointing in a direction of light emission; the at least one first layer of the carrier device containing a conductive layer for power supply to the luminous diode; and the at least one second layer of the carrier device containing a thermal abstraction layer for carrying off the radiated heat of the luminous diode.

The invention refers to a light emitting device and a driving device with a luminous diode, and refers in particular to medical, in particular dental-medical light emitting devices and drives of medical/dental-medical instruments, tools and hand pieces having a luminous diode for illuminating the working area of the instruments and hand pieces.

### BACKGROUND OF THE INVENTION

Drives in the field of medicine and dentistry, such as motors arranged in a housing and driving a medical or dental-medical instrument, tool, or hand piece or angled hand piece coupled via a coupling device to the housing are known. In such housings in an also known way a halogen bulb (also called high-pressure bulb) can be integrated for illuminating the working or handling area of the instrument, tool or hand piece. Bulbs of this type are here arranged preferably in a base in the housing and mostly exchangeable with accordingly loose contacts.

A disadvantage of this known solution of a bulb in a medical/dental-medical drive is, on the one hand, that by the physically caused high emission output of the bulb at the directly adjoining housing sections very high temperatures, so-called hot spots arise on an operating or handle surface which are uncomfortable for a user holding the housing in his hand and limit the time of use of the instrument, tool or hand piece in a certain holding position in the hand.

Therefore for the known drives a high constructive effort is required in order to lower the surface temperature of the housing at least in the operating or handle area, and to keep it in a bearable and/or admissible range for the user.

For that, for example, solutions, such as the arrangement of additional borings for cooling air for an air supply deviated from the motor cooling air have been suggested, however, these solutions are not satisfying as by the deviation of the cooling air at the same time the available amount of cooling air for the instruments, tools or hand pieces put on the drive is reduced, and this again leads to an undesired high heating. In order to keep this within necessary limits, therefore correspondingly sufficient and complex dimensionings of drive and amount of cooling air and/or guide of cooling air have to be reached which are in contrast to a reduction of the driving performance of the motor and the exterior dimensions of the device.

Furthermore it is a disadvantage in the known use of a bulb for the mentioned uses that the thin helix of the filament or its ends can break easily because of, for example, concussions, and this allows only short service times as well as requires the bulb to be exchanged.

From the citation DE 10 2004 061 551 A1 a central hardening device belonging to the technologic background of the invention with a heat sink for abstracting heat is known. This central hardening device contains a longitudinal rod housing with a near and far end, a source of light arranged at the far end, electronic disc circles which are arranged at least partly within the rod housing between the near and the far end, and a heat sink. The source of light can comprise one or more LEDs.

From the citation DE 698 16 716 T2 a dental hand piece with a main part containing a turbine head, a coupling and a source of light for illuminating the point of treatment in the mouth of the patient is known which is characterised in that the light source is a semi layer device arranged in the turbine head. Both solutions are rather complicated so that they are also prone to failures during use according to their intent.

From the citation DE 10 2004 022 095 A1 a medical radiation device is known. This medical radiation device is provided with a main body, a light body of a light emission element which is present in a light exit of the main body, an annular reflection element with an annular reflection surface at the circumference of the light body reflecting the light from it to the front, and a lens element which is present in such a way that it covers a front opening of the reflection element, refracting and being transparent for the direct light from the light body as well as the reflected light from the reflection element. In this device the complete light coming from the lens element is emitted in such a way that it is guided in a specific area of radiation. The construction of this known radiation device is very complicated and therefore very expensive.

Furthermore a bulb, in particular a halogen bulb, has, among others, caused by high making currents occurring in this type of construction and with the desired light performance, generally a low service life in the range of about 40 to 60 hours only, so that because of this exchange high operating costs and/or a high expense even during manufacturing by the use of, for example, ballasts, result.

### BRIEF SUMMARY OF THE INVENTION

Therefore the invention is based on the object to create a light emitting device and a driving device with such a light emitting device for medical and/or dental instruments, tools and hand pieces which shows in a constructively simple way low temperature development for the user at the surfaces of housings in an operating and/or housing handle area.

This problem is solved according to the invention by a light emitting device according to claim 1 and by a driving device according to claim 11.

In order to overcome the disadvantages of known arrangements described before thus according to the invention a light emitting device for a drive of medical instruments and/or hand pieces is provided, characterised by a carrier device consisting of at least one first layer and at least one second layer; and a luminous diode arranged at a surface of the carrier device pointing in a direction of light emission; the at least one first layer of the carrier device containing a conductive layer for the supply of power for the luminous diode; and the at least one second layer of the carrier device containing a heat abstraction layer for abstracting emission heat of the luminous diode.

The luminous diode is here preferably a full-load luminous diode or power LED which is provided based and exchangeable or fixedly built in, and conveniently generates light with good efficiency and low heat development. The use of a luminous diode is also convincing with regard to a long-term use and the availability of the (dental-) medical instrument resulting therefrom.

For improving the heat transport in the conductive layer it is of advantage if the conductive layer of the carrier device consists of copper or thick copper. Furthermore it is an advantage for that if the conductive layer occupies a maximum surface of the carrier device.

Preferably in addition the preferably at least one second layer of the carrier device is a layer consisting of a heat conductive paste and/or a heat paste print and/or a heat conductive film, and furthermore preferably on the heat abstraction layer at least one cover element of a material with a high heat conductivity is arranged.

The heat transport is in particular supported if the at least one second layer of the carrier device is a metal carrier layer, for example of aluminium, copper, steel or a metal alloy which is laminated for providing other functions with a heat conductive insulation layer and a conductor, for example copper.

Preferably the at least one first layer of the carrier device is arranged in the direction of light emission below the at least one second layer of the carrier device. In this case preferably the at least one layer of the carrier device is a flame-retarding printed board of epoxy resin and glass cloth on which the conductive layer for the electric contact of the luminous diode is applied. In this case in a modification the printed board is designed thicker than the conductive layer.

The heat transport of the light emitting device is also improved by the fact that the conductive layer, with the exception of interruptions for electric contact of the luminous diode, extends essentially over the complete surface of the carrier device, and is again improved by the fact that the heat abstraction layer is arranged on sections of the conductive layer which are not occupied by the luminous diode and its electric contacts.

It is also preferred that the carrier device is designed in the shape of a flat, annular disc arrangement and the heat abstraction layer, and the at least one cover element cover the surface of the disc-ring shaped carrier device in such a way that a recess forms in which the luminous diode and its electric contacts are arranged.

In an advantageous embodiment the at least one second layer of the carrier device is arranged in the direction of light emission above the at least one first layer of the carrier device.

Alternatively to that, however, it is also possible that the at least one second layer of the carrier device is arranged in the direction of light emission below the at least one first layer of the carrier device and extends over the entire surface of the at least one first layer.

Preferably the at least one first layer of the carrier device is a flame-retarding printed board of epoxy resin and glass cloth on which the electric contacts of the luminous diode are applied.

Thus in a preferred embodiment the light emitting device contains in direction of the light emission: the printed board of epoxy resin and glass cloth; the conductive layer arranged on the printed board; the luminous diode arranged on the conductive layer; the at least one contact of a conductive material for the power supply of the diode formed in the conductive layer; the heat abstraction layer arranged in sections on the conductive layer; and the at least one cover element supported on the heat abstraction layer.

In an alternative, preferred embodiment according to the invention the light emitting device contains seen in the direction of light emission: The metal carrier layer; the insulating layer laminated on the metal carrier layer; the conductor laminated on the metal carrier layer; the luminous diode arranged on the conductor and contacted in the conductor; the heat abstraction layer arranged in sections on the insulating layer; and the at least one cover element supported on the heat abstraction layer.

In another alternatively, preferred embodiment according to the invention the light emitting device contains, seen in the direction of light emission: the heat abstraction layer; the metal carrier layer arranged on the heat abstraction layer; the insulating layer laminated on the metal carrier layer; the conductor laminated on the metal carrier layer; the luminous diode arranged on the conductor and contacted in the conductor; and the at least one cover element supported on the conductor.

In the last-mentioned embodiment it is, of course, basically possible that also between the conductor and the at least one cover element supported on the conductor also a heat abstraction layer is provided.

As already mentioned the problem is also solved by a driving device for driving medical instruments and/or hand pieces, characterised by a housing with a first section of a first volume for receiving a driving motor, and a second section of a second volume for coupling an instrument and/or hand piece driven by the driving motor; and a carrier device with a luminous diode arranged thereon for emitting light in the direction of an area in the environment of the instrument or hand piece, with the carrier device providing a good heat coupling to the housing and/or sections thereof it for a good abstraction of heat generated by the luminous diode.

In such a driving device preferably the carrier device is designed in the shape of an annular disc or a segment of it, the surface of it, which carries the luminous diode extends essentially rectangular to the longitudinal extension of the rotational axis of the driving motor.

Naturally in such a driving device the first volume can be larger than the second volume, or the first volume can be smaller than the second volume.

Excellent heat qualities are reached in such a driving device by the use of a light-emitting device as briefly described before.

This is advantageously further supported, if for cooling the heat radiation generated because of the heat output of the luminous diode at the carrier device a maximum segment area with a heat contact surface at a first side by using a heat abstracting material and/or at a second side a heat abstracting material on an insulated metal substrate is provided.

This advantageous effect is even enlarged by the fact that for cooling a good heat transfer to the housing or parts thereof is produced by means of a device for generating a pre-tension of a spring and/or an elastomer element.

An advantageous development provides that the device for generating a pre-tension of a spring or the elastomer element has spring qualities, and is preferably formed of Silicon which can in particular be sterilised, wherein at the same time or additionally a seal toward add-on pieces, such as, for example, the device in the instrument or hand piece or its base, center or head piece forms. By means of these plastic properties the already before described positive effect with regard to cooling or the good heat transmission to the housing or to the parts is reached. At the same time, however, because of the design of the elastomer element in the form of Silicon which can be sterilised a seal is reached so that additional sealing measures can be omitted.

Conveniently here at the elastomer element at least one medium pipe with, if necessary, internal medium lines is arranged or can be connected there. Here in the case of the connection of the medium pipe with the at least one medium connection it is assumed that the medium connection has as much connection parts as are necessary to connect the internal medium lines to one another. Advantageously then on the side opposite of the medium pipe there is another medium connection to carry the media on, accordingly.

Furthermore the invention suggests that at the elastomer element also at least one liquid supply can be connected or is provided, which has at least one stop device for back absorption on the side opposite of the liquid supply. Of course, it is also provided according to the invention that the liquid supply is attached to the elastomer element with suitable connections or couplings.

Because of the measures described before besides an improved use of the driving device for medical or dental instruments, tools and hand pieces furthermore surprisingly even with high light and emission performances of a light source built in a longer time of use and service life of the light source is provided.

Furthermore the problem according to the invention is also solved by a medical or dental instrument or hand piece having a carrier device with a luminous diode arranged on it for emitting light in the direction to an area in the environment of the instrument or hand piece, the carrier device providing a good heat coupling to the housing of the instrument or hand piece and/or their sections for a good abstraction of heat generated by the luminous diode.

The concept according to the invention makes it possible to employ a carrier device at different places. The arrangement of the carrier device carrying the luminous diode however is possible, on the one hand, on the driving device, on the other hand, also on the medical or dental instruments or hand pieces which can be exchangeable put on a driving device. As the heat development of the arrangement of the light emitting device according to the invention is much less by the use of the luminous diode and, at the same time, the two-dimensional construction of the light emitting device by means of the suggested carrier device is coupled thermally much better to the respective housings, these heat developing, energy consuming elements can be positioned in the area where the light is actually needed. It has to be taken into consideration here that the front head area of the instrument or hand piece is introduced into the mouth and therefore here first of all no excessive heat development is desired in order to prevent the patient from being hurt. The concept according to the invention allows, however, an arrangement exactly in this front region as an excessive heat development just does not occur anymore. The use of suitable optical waveguide elements or systems (optical fibers and so on) is reduced, if possible even completely omitted if the light emitting luminous diode is arranged, for example, in the front area at the working tool, in the head area of the instrument or hand piece.

In this connection it should be mentioned that usually suitable optical waveguide elements (optical fibers and so on) are arranged in the hand piece or instrument the coupling point of which is positioned in the base area of the instrument in such a way that the luminous diode provided at the driving device supplies at least a part, if not the main part, of its emitted light into the optical waveguide system.

The carrier device arranged in the area of the medical or dental instrument or hand piece has preferably the form of an annular disc or a segment, the luminous diode emitting light preferably in the direction of the longitudinal extension of the housing of the instrument or hand piece, in particular in the direction of the head area of the instrument or hand piece, whereof preferably results that the area carrying the luminous diode extends essentially rectangular to the longitudinal extension of the housing of the instrument or hand piece.

The invention here comprises also solutions where the light emitting device described in the beginning is used at the instrument or hand piece suggested according to the invention, but also has a design at the driving device alternatively to that, like the one described above. Through a good heat coupling of the carrier device to the respective volume the heat is effectively abstracted and spread so that the complete loss performance is transferred to the environment on a low temperature level.

Thereof results is that the features mentioned before which have been discussed in connection with the driving device and the carrier device can be employed in the same way, in order to prevent repetitions, also with the instrument or hand piece belonging to the invention.

In a preferred modification of the invention it is provided here that the carrier device is arranged at the instruments' or hand pieces' base, center or head area. Of course, a suitable combination is possible, that means that an instrument or hand piece or even another device has a number of carrier devices each equipped with a luminous diode, and thus a more complex, but also more comfortable illumination is possible. At the respective spots then, if necessary, also another optical waveguide system can be provided.

For supplying the luminous diode with energy, preferably electricity, in the base region of the instrument or hand piece at least one, usually two or more energy conducting contacts are provided. It has to be taken into consideration here that with an use of the instruments according to their purpose the user always uses a number of instruments or hand pieces exchangeable on a shared driving device, and in the coupling area of this driving device then suitable energy conducting contacts communicating with it are provided. Wires provided at the luminous diode end at the energy conducting contacts in the base area and then conduct the energy from the driving device to the luminous diode if this instrument or hand piece is connected with a corresponding hand piece carrier or driving device.

### BRIEF DESCRIPTION OF THE DIFFERENT VIEWS OF THE DRAWINGS

In the following the invention is described in detail by means of embodiments referring to the drawing. In the figures:

FIG. 1 a simplified perspective drawing of a known driving device for medical and/or dental instruments, tools or hand pieces according to the state of the art (st. o. t. a.);

FIG. 2 a simplified perspective drawing of a driving device for medical and/or dental instruments, tools or hand pieces according to an embodiment of the invention;

FIG. 3 a very simplified perspective drawing of a light emitting device with a bulb and a carrier according to an embodiment of the invention; and

FIGS. 4a to 4c simplified side views of embodiments of the construction of the light emitting arrangement according to FIG. 3;

FIG. 5, FIG. 6 each in a perspective drawing the driving device according to the invention in connection with an instrument or hand piece;

FIG. 7a, FIG. 7b each in a perspective view another modification by using the hand piece or instrument according to the invention.

FIGS. 8a to 8c further embodiment of a coupling device with light emitting device according to the invention.

### DETAILED DESCRIPTION OF THE PREFERRED EMBODIMENT

In the figures identical or corresponding elements each are indicated by the same reference numbers and therefore, if not serving a purpose, are not described anew.

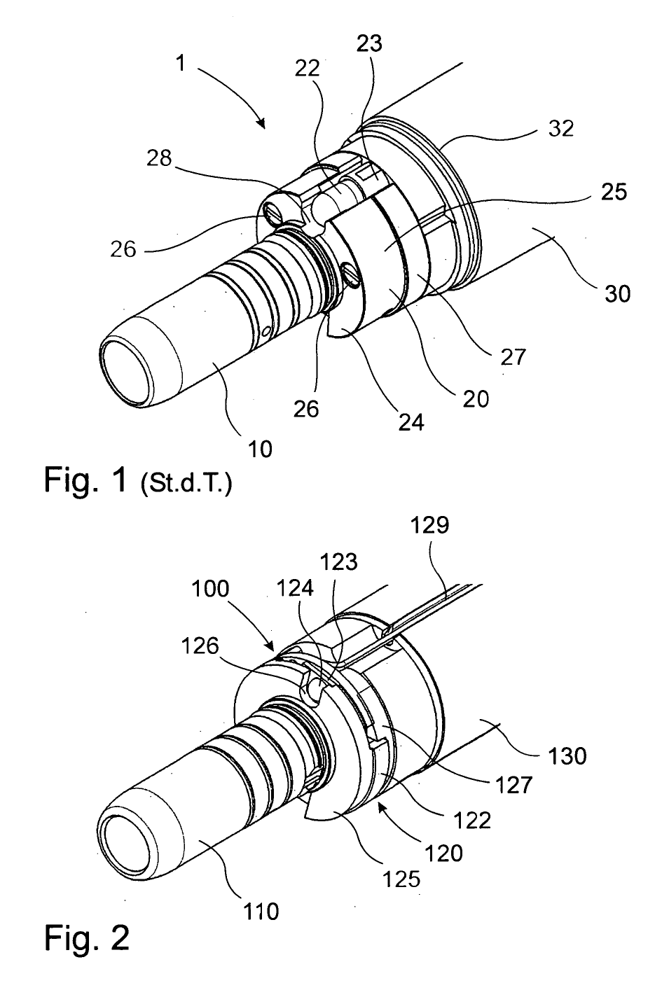

FIG. 1 shows a simplified perspective illustration of an exterior view of a known driving device 1 for medical and/or dental instruments, tools or hand pieces. The driving device 1, which is altogether surrounded by a housing, which is not described and may be multipart, is subdivided essentially in three functional sections.

A first functional section of the driving device 1 is a coupling device 10 for a plug-in and/or catching, non-positive coupling of a medical or dental instrument, tool or hand piece (not shown) which has to be driven the arrangements of which are usually known and therefore are not described in detail.

A second functional section of the driving device 1 is formed by a light emitting arrangement 20 in which a bulb or high pressure light 22, preferably a halogen bulb is based in a socket 23 mounted in the housing and which can be plugged in contact connections on the housing.

A third functional section of the driving device 1 finally consists of a driving section 30 in which on the interior of housing a medical or dental drive or motor (not shown) is arranged which is connected non-positive with the coupling device 10 and makes the medical or dental instrument, tool or hand piece which has to be driven moving in a pre-determined way. The drive or motor itself is known and is therefore not described in detail.

As it can be seen in FIG. 1 the light emitting arrangement 20 is arranged between the coupling device 10 and the driving section 30, and has a front face 24 of a body 25 of, for example, metal pointing at the coupling device 10. The body 25 is attached by means of screwings 26 directly to a base carrier plate 27 or through this to the driving section 30, and encircles, open to the side of the circumference of the circular housing in the shown arrangement, tightly the bulb 22 in a recess 28 of the body 25. The body 25 itself is massively designed with a volume as large as possible depending on the housing in order to receive and abstract, on the one hand, the heat development of the bulb 22 as well as, on the other hand, to be able to provide room for a possibly necessary coolant supply. The abstraction direction of the bulb 22 is orientated out of the front face 24 in the direction of one end of the coupling device 10 facing the work area in such a way that light emitted by the bulb 22 illuminates a work area of the user in front of the coupled instrument, tool or hand piece.

If in the known driving device the instrument, tool or hand piece is put on the coupling device 10 ready for operation, one end facing the driving section of a (not shown) housing of the instrument, tool or hand piece is in contact with, for example, a graduation 32 of the housing of the driving section 30, and encircles here also the light emitting arrangement 20 in such a way that the circumference of the body 25, the circumference of the base carrier plate 27 and the bulb 22 are placed closely below the housing of the instrument, tool or hand piece. The result of this are, as this housing is on the outside at the same time the operating or handle surface of the instrument, tool or hand piece for a user, by the physically caused high emitting performance of the bulb 22 and the heat transport of the resulting heat to the housing, very high temperatures at directly adjacent housing sections, so-called hot spots as locally very hot places which are uncomfortable for the user holding the housing even if a cooling for these housing sections is present, and which restrict the using time or holding time of the instrument, tool or hand piece.

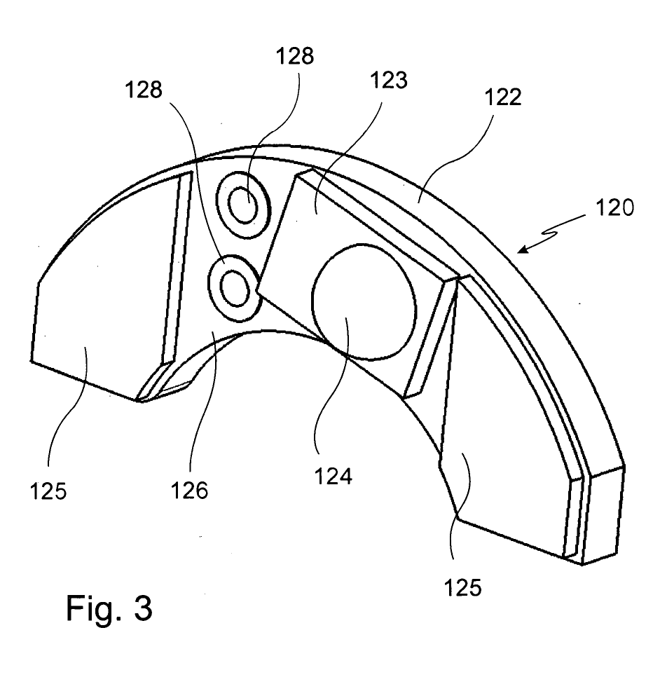

FIG. 2 shows a simplified perspective view of a driving device 100 for medical and/or dental instruments, tools or hand pieces according to an embodiment of the invention.

The basic construction of the driving device 100 according to the embodiment corresponds with the known driving device 1, that means the driving device 100 also has as a first functional section a coupling device 110, as second functional section a light emitting device 120 and as third functional section a driving section 130.

While the coupling device 110 and the driving section 130 may correspond already for compatibility reasons with the ones of the known driving device 1, and, as known, are not described in detail, and the light emitting device 120 is arranged such as the known light emitting arrangement 20 between the coupling device 110 and the driving section 130 with the same light emitting direction, however, the construction of the light emitting device 120 of the driving device 100 differs basically from the light emitting arrangement 20 of the driving device 1. This will be described in detail in the following by means of FIG. 2.

As it can be seen in FIG. 2 the light emitting device 120 consists simplified of a carrier 122 on which a luminous diode 124 fixedly attached to an intermediate carrier 123 is arranged.

The luminous diode 124 is, for reaching a good light output for medical/dental purposes, preferably a full-load LED or power LED which can be operated because of a larger chip surface with high electricity. Because of high output of the full-load luminous diode developed by that, for an optimum of physical properties and service life a good heating of the diode is one of the concept and interpretation factors of an application.

A cover element 125 with a recess 126 which encloses the luminous diode 124 openly in the direction of the circumference is arranged in the direction of light emission above the carrier 122 supported on it. Alternatively the cover element 125 can also be formed fixedly connected with the carrier 122, in this case the recess 126 having an opening area which offers enough space for assembling and contact of the luminous diode 124 on the carrier 122. The contact of the luminous diode 124, not shown in FIG. 2, is preferably carried out on the surface of the carrier 122 facing the light emission, while the power supply to the luminous diode 124 is carried out from the backside (opposing the light emission facing surface of the carrier 122) of the carrier 122 through conductive lines 129 guided for example in a groove or provided recesses in the driving section 30 indicated in FIG. 2. It is mentioned that the contact of the luminous diode 124 can be carried out in any way according to a through, along or passing guide of conductive lines from the backside (the side of the driving section 130) of the carrier 122 to its front side (the light emitting side of the light emitting device 120).

The carrier 122 of the light emitting device 120 can be designed in particular as disc-shaped carrier plate or in the shape of a segment of such a carrier plate or the like with a luminous diode arrangement surface essentially rectangular to the longitudinal extension of the motor or its rotational axis, and can have a construction in such a way that it provides for the light generated by the luminous diode 124 arranged on it with good efficiency and therefore low heat development a very good heat coupling, for example in the direction to the driving section 130 via an in-between arranged elastomer plate or disc 127 to the adjoining and/or other housing parts.

By means of that the heat generated by the luminous diode 124 can be carried off fast and well even without expensive active or voluminous cooling measurements, without the occurrence of unacceptable or uncomfortable high temperatures for the operator at the operating or handle surfaces. As an additional effect by such a design of the carrier 122 with a at the same time shock-proof assembly of the luminous diode 124 because of the invention as the operating time as well as the endurance of the bulb is considerably increased and therefore premature failures of them do not occur, so that as a result it is maintenance-free with clearly lower expenses for maintenance and spare parts.

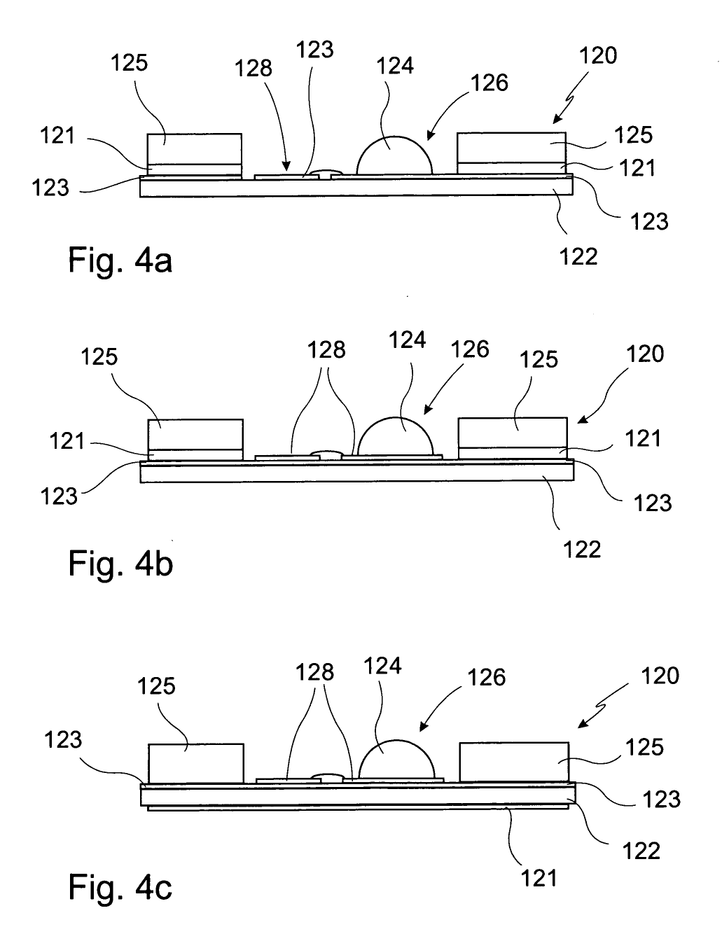

FIG. 3 shows for further explanation a largely simplified perspective drawing of the light emitting device 120 and its essential elements according to an embodiment. Here the orientation of the light-emitting device 120 shown in FIG. 3 corresponds roughly with the construction position of it in FIG. 2, and the carrier 122 is designed in a preferred embodiment as segment of an annular disc.

It is mentioned that the light-emitting device 120 may comprise an annular disc of this type or several segments thereof of this type, wherein in the case where only one luminous diode 124 is provided on the carrier 122, other segments may consist of corresponding passive blind segments of suitable material, which contribute only to the increasing of the heat abstraction. Of course the light-emitting device 120 may, however, also comprise several active carrier segments on which each time at least one luminous diode 124 is arranged. In this case the amount of emitted light of the light emitting device 120 can be increased advantageously, and/or be guided in pre-determined directions, or, if optionally single luminous diodes 124 are provided for switching on or off, the emitted amount of light can selectively be raised or reduced.

In detail, in FIG. 3 first of all the carrier 122 itself and parts of the cover element 125 can be discerned. The cover element 125 consists advantageously of a metal, for example a suitable steel with good heat conductibility in order to receive the heat generated by the luminous diode 124 during its operation through its contact surfaces with the carrier 122 and through the medium, for example air, present in the also visible recess 126 encircled by the parts of the cover element 125 and to carry it off to the surrounding housing parts. Furthermore according to FIG. 3 in the recess 126 of the intermediate carriers 123 on the carrier 122 and again on it the luminous diode 124 is arranged, and contacts 128, which for power supply purposes of the luminous diode 124 are connected with the intermediate carrier 123, are provided.

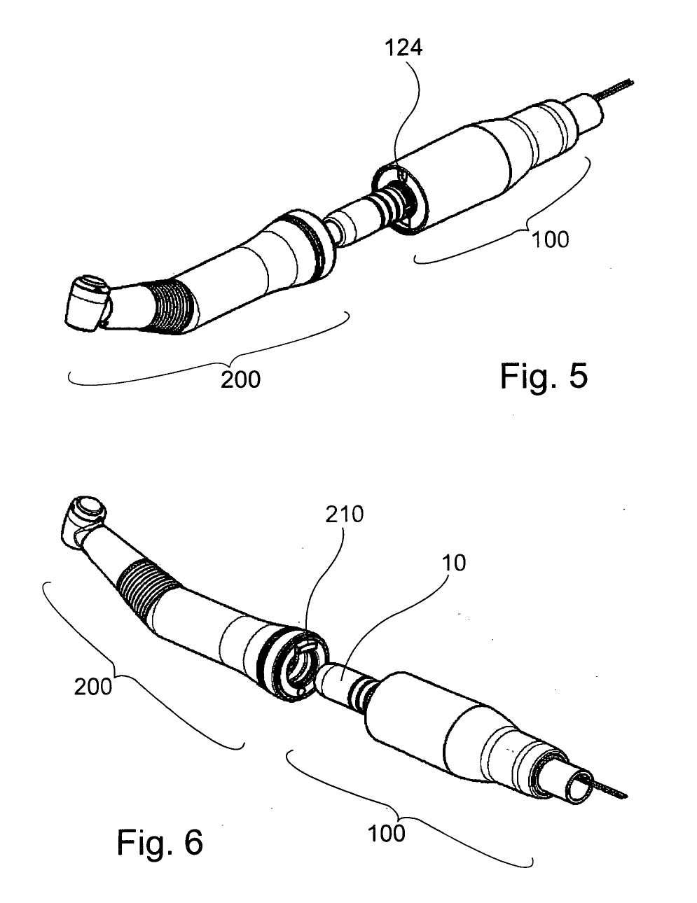

The light emitting device 120 shown very simplified in FIG. 3 is in preferred embodiments constructed with several layers of different materials and/or materials and/or elements. FIGS. 4a to 4c shown in simplified side views of the light-emitting device 120 according to FIG. 3 such embodiments by means of examples.

According to FIG. 4a in a first preferred embodiment the light-emitting device 120 consists, seen from the bottom to the top, first of all of a printed board or printed card or a circuit board forming a kind of a basic board of the light-emitting device 120 in the form of the carrier 122. The printed board is generally a carrier board of flame-retarding, insulating material with fixedly attached, conductive connections, and consists preferably of so-called FR4 material that means a composite of an epoxy resin and a glass cloth (glass fiber mats drenched with epoxy resin), without being restricted to it.

In the light emitting direction next a conductive layer 123, for example of copper, is arranged on the carrier 122 which corresponds with the before-mentioned intermediate carrier 123 according to FIG. 3. In the embodiment shown in FIG. 4a the conductive layer 123 is designed with interruptions extending over the complete carrier 122 wherein by means of the interruptions in the conductive layer 123 also the contacts 128 in the recess 126 are produced out. In the recess 126 furthermore the luminous diode 124 is shown which also is assembled on the conductive layer 123 in a suitable way, and is contacted with indicated bond or soldered joints not described in detail via the contacts 128 for power supply. The conductive layer 123 lies, as a rule, on an electric ground potential of the complete arrangement so that it goes without saying that the contacts 128 are suitably electrically insulated against this ground potential.

It is mentioned that the conductive layer 123 has to be thick compared with the usual strip conductors on printed boards, for example as thick copper with copper thickness of more than 200 to 400 μm in order to guarantee a clearly better lateral heat transport away from the luminous diode 124 in the margin areas of the light emitting device 120, and to make higher full-load current capacities possible, as they can occur when using a full-load luminous diode 124.

Furthermore in the light emitting device a so-called “thermal interface material” (TIM) or heat intermediate layer material 121, for example a heat conducting paste, heat paste print or heat conductive film, is applied to the conductive layer 123.

The use of a heat conductive film can offer here an advantage in that respect that an optimal thermal contact between the assembly surfaces is reached, a simple handling of the film is possible by means of fixing with gluing, and undesired exhalation of gas and drying is avoided.

The position of this heat intermediate layer material 121 at this place serves in the shown embodiment for transmitting the heat generated by the luminous diode 124 and abstracted via the conductive layer 123 upward, that means in the direction of light emission. To the bottom, that means in the direction of the carrier 122 in this case the heat conductibility of this material may be not sufficient for a dis-heating of the luminous diode 124 without expensive and costly measurements, such as for example additional thermal through contacts by using a material with a high coefficient of thermal conduction or metal cores.

Eventually the cover element 125 is arranged on the heat intermediate layer material 121 according to FIG. 4a, or, with a segment-like design of the light emission device 120, cover elements 125 are arranged which preferably consist of a material with good heat conductibility, for example a suitable steel type, and provide a heat coupling of the light emitting device 120 to the surrounding housing.

According to FIG. 4b the light emitting device 120 has, in contrast to the light emitting device 120 according to FIG. 4a, in this case carrier 122 forming the lowest layer of a material with good heat conductibility, for example a metal such as aluminium. Such a carrier is, for example, a so-called insulated metal substrate (IMS), that means a metal carrier for, for example, electronic circuits, of, for example, aluminium, copper or steel or a suitable alloy and the like, which, as a rule, is laminated on one side with a thin insulating layer which conducts heat well, and copper.

To the carrier 122 with good thermal conductibility in the direction of the light emission then, in contrast to the embodiment according to FIG. 4a, a thinner intermediate carrier 123 is applied which consists in this case, for example, of the pre-mentioned FR4 material or a laminating as described before, and to which the contacts 128 are applied in the form of conducting surfaces of, for example, copper for the power supply of the luminous diode 124.

Furthermore on the thinner intermediate carrier 123, the same as in the embodiment according to FIG. 4a, the recess 126 surrounding and in the direction of light emission subsequently following, first of all, the heat intermediate layer 121 and the cover element or elements 125 are arranged.

The embodiment shown in FIG. 4b of the light emission device 120 shows, compared with the embodiment of FIG. 4a, an even more improved heat transport into the surrounding housing as the heat generated by the luminous diode 124 is carried off through the thinner intermediate layer 123, on the one hand, via the carrier 122 to the bottom, that means to the side of the driving section 30, an, on the other hand, via the heat intermediate layer 121 and the cover element 125 also on both sides to the top, that means in the direction of light emission to the surrounding housing.

The lower thermal conductibility of the intermediate layer 123 does not act here disadvantageously restricting because of the low thickness of this layer, and can be optimised by means of suitable dimensioning and guide of the contacts 128. Furthermore, this embodiment is an economical realisation also by means of the fact that the conductive layer is applied to the thinner intermediate layer 123 only for the contacts 128 and not on a large scale, and thus allows conductive material to be saved.

In another preferred embodiment according to FIG. 4c, which is basically constructed similar to the one according to FIG. 4b, so that corresponding and identically acting elements do not have to be described anew, the heat intermediate layer 121 is not arranged between the intermediate layer 123 and the cover element 125, but on the underside of the carrier 122, facing the driving section 30.

In this embodiment by means of that because of the improved heat coupling of the light emitting device 120 to the driving section 30 advantageously a once more improved thermal transport in the area of the medical/dental driving devices is reached, which are positioned farther away from the operating and handle surface for the user, while a lower thermal transport is carried out into the cover element 125 so that altogether the distribution of the thermal transport is changed in favour of a transport of a larger amount of heat in the areas farther away of the driving device and a transport of a smaller amount of heat in the operating and handle surfaces of the surrounding housing.

Of course, a combination of the embodiments according to FIG. 4b and FIG. 4c, where the heat intermediate layer 121 is arranged at the position shown in FIG. 4b as well as in the position shown in FIG. 4c, is possible in a (not shown) modification, so that the thermal transport can be maximised in upward as well as in downward direction.

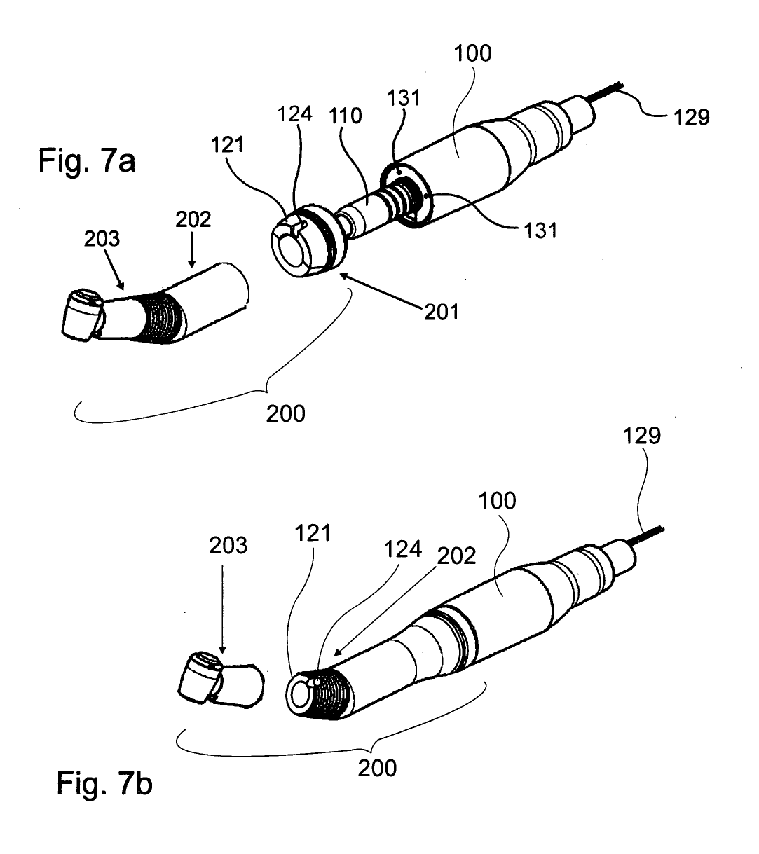

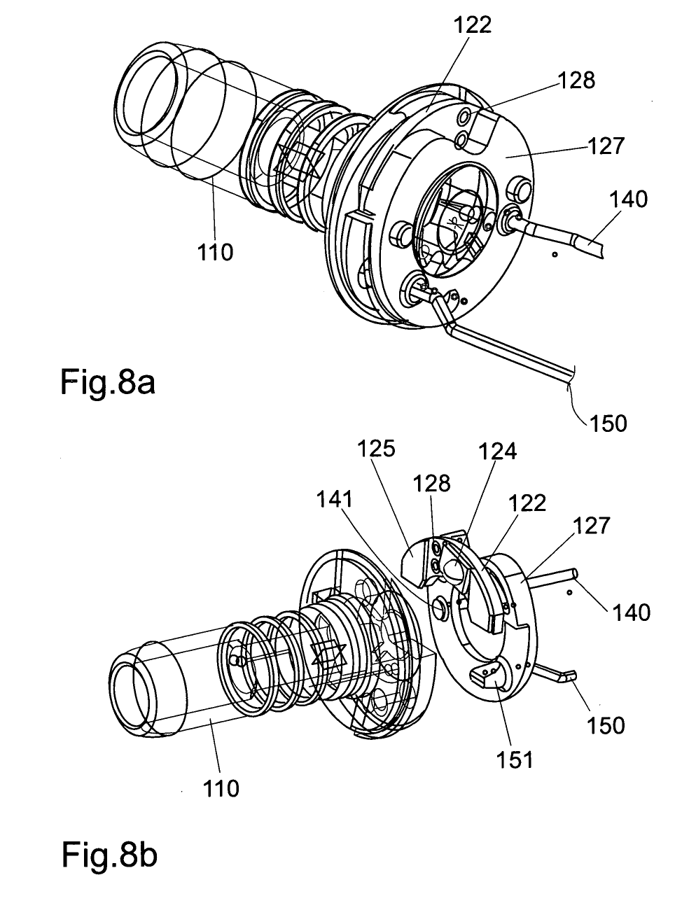

In FIG. 5 and FIG. 6, respectively, the use of the driving device 100 according to the invention together with a medical or dental instrument or hand piece 200 is shown each in a perspective view. Another detailing in particular of the instrument or hand piece 200 is done in FIGS. 7a, 7b. The instrument or hand piece 200 has an opening so that it can be slipped on the coupling 10. By means of the coupling driving moment, but also media such as light, gas, pressurised air, liquids, electricity, energy and so on are guided in the center or head area of the hand piece. In the here shown modification according to the invention the luminous diode 124 is provided in the driving device 100. In a coupling area 210 provided in the base region of the hand piece 200 a waveguide system starts, such as for example optical fibers in order to receive the light emitted by the luminous diode 124 and guide it in the head area.

In FIGS. 7a, 7b in particular two modifications of the medical or dental instrument or hand piece according to the invention is shown which carries a luminous diode 124 on a carrier device 121.

The hand piece 200 is subdivided here in a base area 201, which has in particular the medium connection to the respective medium end channels at the driving device 100.

A center area 202 then joins forming the intermediate part between the base area 201 and the head area 203 where the tool or the like is arranged.

The construction of the carrier device 121 is highly variable. It is, for example, designed as shown in FIGS. 3, 4a to 4c.

In FIG. 7a the carrier device 121 is integrated in the base area 201 and uses there the area conically tapering in the direction if the head area 203. The result is here a very space-saving arrangement.

For a clearer overview in the drawing of FIG. 7a or 7b the instrument/hand piece 200 is shown subdivided in its respective areas. Actually this is, when in use, of course, put together or in one piece or connected to each other.

In FIG. 7b the carrier unit 121 is provided with the luminous diode 124 in the center piece 202, already in this design another waveguide system being deleted as in use already the center area also gets in the oral cavity and thus results in an illumination of the working area.

It is, of course, possible, even if not shown here, to arrange the carrier device 121 with the luminous diode 124 in the head area 203.

In order to supply energy to the luminous diode 124 arranged in the base area 201, the center area 202 or the head area 203, in particular electricity, on the end side of the base area 201 facing the driving device 100 suitable (unfortunately covered) energy conducting contacts are provided interacting accordingly with suitable energy conduction contacts 131 at the endplate of the driving device 100. Here corresponding guide noses and recesses are provided in the elements which can be put together, in order to secure an exactly angled connection of the hand piece or instrument 200 and the driving device 100.

It is also mentioned that the light emitting device 120 may be provided additionally with (not shown) optical systems for the luminous diode 124 itself, supporting reflectors and/or lenses and/or prisms in order to increase the capability of the light emitting device 120 without being restricted to it. Furthermore the cover element or the cover elements 125 do not need to be massive, but for tuning with a respectively suited thermal transport they can have in a suitable way recesses and borings or be designed as corresponding guided walls, so that, with at the same time sufficient heat abstraction, further advantageously less material is needed and a smaller weight of the driving device can be reached.

As described above already by the use of a full-load LED or power LED the heat output generated by the light source and thus the heat development of the light emitting device 120 has been reduced. The required cooling then can be achieved without borings for cooling air on a passive way by providing sufficiently or maximally large segment surfaces, and with thermal contact surfaces on an upper side or upper surface via a heat intermediate layer (TIM; “thermal interface material”), and/or an underside or backside via the heat intermediate material on the IMS (aluminium carrier). A good heat transmission can be reached additionally by means a constructive solution using pre-tension of a spring in an additional separate structural component, or alternatively, with the same effect, with the elastomer part 127. Essential advantages result in a considerably increasing of the service life of the light emitting device 120 and the deletion of costs for maintenance and the exchangeability for an end user.

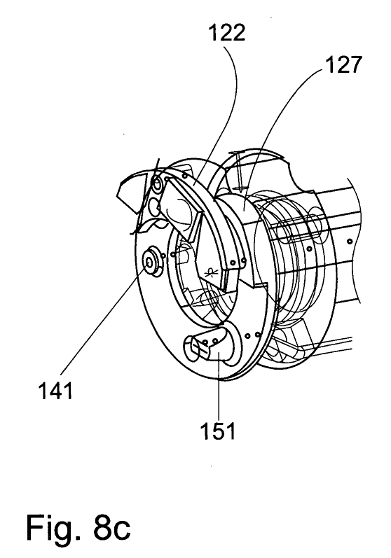

FIGS. 8a to 8c show in exploded views further variant of the design of a coupling device with light emitting device and medium connections according to the invention. Already presented reference numbers are used again in the same way as in the figures already presented. In contrast to the already presented modifications of the invention here, in particular in FIGS. 8a and 8b an elastomer disc or plate 127 is provided very clearly as device for producing a pre-tension of a spring at the coupling device 110 which has on the one side a medium pipe 140 which is connected there. Furthermore, opposite also a liquid supply 150 is provided which is also arranged at the elastomer disc or plate as elastomer element 127. Between the elastomer element 127 and the end of the coupling device 110 serving for connecting another intermediate part or instrument again the carrier 122 is arranged in the already described characteristics. The elastomer element 127 is, in contrast to the modifications presented so far, produced from Silicon which can be sterilised and is in particular provided with elastic qualities. By means of that it is possible to produce sufficient pressure force in assembled condition which is sufficient to get the desired positive heat abstraction from the luminous diode or illumination device. At the same time by the design of the elastomer element 127 a seal toward add-on pieces of synthetic material or steel is reached which, as already mentioned, may be the hand piece 200 or its base 201, center 202 or head 203 area. This cannot be discerned from the here shown FIGS. 8a to 8c.

In particular in FIGS. 8b and 8c it is shown that at the elastomer element 127 a back absorption stop device 151 is provided which generates a back absorption stop when the water pressure is turned off.

Furthermore it can be seen that also a medium pipe connection 141 is provided on the side of the elastomer element 127 opposite the medium pipe 140. In FIG. 8c the same elements are shown one more time from another view.

Although the invention has been described by exact examples which are illustrated in the most extensive detail, it is pointed out that this serves only for illustration, and that the invention is not necessarily limited to it because alternative embodiments and methods become clear for experts in view of the disclosure. Accordingly changes can be considered which can be made without departing from the contents of the described invention.

1. A light emitting device for a drive for medical or dental instruments and/or hand pieces, characterised by
a carrier device consisting of at least one first layer and at least one second layer; and
a luminous diode arranged at a surface of the carrier device pointing in a direction of light emission; where
the at least one first layer of the carrier device contains a conductive layer for power supply of the luminous diode; and
the at least one second layer of the carrier device contains a heat abstraction layer for abstracting radiated heat of the luminous diode.

2. The light emitting device according to claim 1, characterised in that the luminous diode is a full-load luminous diode or a power LED, which is provided based and exchangeable, or fixedly built-in, and/or the luminous diode generates light with good efficiency and small heat development, and/or the conductive layer of the carrier device consists of copper or thick-copper.

3. The light emitting device according to claim 1, characterised in that the conductive layer occupies a maximum surface of the carrier device, and/or the at least second layer of the carrier device is a layer consisting of a heat conductive paste and/or a heat paste print and/or a heat conductive film, and/or on the heat abstraction layer at least one cover element of a material with high heat conduction is arranged.

4. The light emitting device according to claim 1, characterised in that the at least one second layer of the carrier device is a metal carrier layer of, for example, aluminium, copper, steel or a metallic alloy, and/or the at least second layer of the carrier device is laminated with a heat conducting insulation layer and a conductor, for example copper.

5. The light emitting device according to claim 1, characterised in that the at least one first layer of the carrier device is arranged in the direction of light emission below the at least one second layer of the carrier device, and/or the at least one first layer of the carrier device is a flame-retarding printed board of epoxy resin and glass cloth on which the conductive layer for electric contacting of the luminous diode is applied.

6. The light emitting device according to claim 1, characterised in that the printed board designed as carrier board is thicker than the conductive layer, and/or the conductive layer extends essentially across the entire surface of the carrier device with the exception of interruptions for electric contacting of the luminous diode.

7. The light emitting device according to claim 1, characterised in that the heat abstraction layer is arranged on sections of the conductive layer which is not occupied by the luminous diode and its electric contacting, and/or the carrier device is designed in the shape of a flat, annular disc arrangement, and the heat abstraction layer and the at least one cover element cover the surface of the disc-annular carrier device in such a way that a recess is formed in which the luminous diode and its electric contact are arranged.

8. The light emitting device according to claim 1, characterised in that the at least one second layer of the carrier device is arranged in the direction of light emission above the at least one first layer of the carrier device, and/or the at least one second layer of the carrier device is arranged in the direction of light emission below the at least one first layer of the carrier device and extends over the complete surface of the at least one first layer.

9. The light emitting device according to claim 1, characterised in that it contains seen in the direction of light emission:
the printed board of epoxy resin and glass cloth;
the conductive layer arranged on the printed board;
the luminous diode arranged on the conductive layer;
the at least one contact shaped in the conductive layer of conductive material for power supply of the luminous diode;
the heat abstraction layer arranged in sections on the conductive layer; and
the at least one cover element supported on the heat abstraction layer;
or that it contains seen in the direction of light emission:
the metal carrier layer;
the insulating layer laminated on the metal carrier layer;
the conductor laminated on the metal carrier layer;
the luminous diode arranged on the conductor and contacted in the conductor;
the heat abstraction layer arranged in sections on the insulating layer; and
the at least one cover element supported by the heat abstraction layer;
or that it contains seen in the direction of light emission:
the heat abstraction layer;
the metal carrier layer arranged on the heat abstraction layer;
the insulating layer laminated on the metal carrier layer;
the conductor laminated on the metal conductive layer;
the luminous diode arranged on the conductor and contacted in the conductor; and
the at least one cover element supported on the conductor.

10. The light emission device according to claim 1, characterised in that between the conductor and the at least one cover element supported on the conductor also a heat abstraction layer is provided.

11. A driving device for driving medical or dental instruments and/or hand pieces, characterised by
a housing with a first section of a first volume for receiving a driving motor and a second section of a second volume for coupling an instrument and/or hand piece driven by the driving motor; and
a carrier device with a luminous diode arranged on it for emitting light in the direction to an area in the environment of the instrument or hand piece, the carrier device providing a good heat coupling to the housing and/or its sections for a good abstraction of heat generated by the luminous diode.

12. The driving device according to claim 11, characterised in that the carrier device is designed in the form of an annular disc or a segment of it, the surface of which carrying the luminous diode extending essentially rectangular to the longitudinal extension of the rotational axis of the driving motor, and/or the first volume being larger than the second volume or the first volume being smaller than the second volume.

13. The driving device according to claim 11, characterised in that the light emitting device for a drive of medical or dental instruments and/or hand pieces consisting of
a carrier device comprising at least one first layer and at least on second layer; and
a luminous diode arranged on a surface of the carrier device pointing in a direction of light emission; wherein
the at least one first layer of the carrier device contains a conductive layer for power supply of the luminous diode;
and
the at least one second layer of the carrier device contains a heat abstraction layer for abstracting emitted heat of the luminous diode,
is used, and/or for cooling the heat emission generated because of the heat output of the luminous diode at the carrier device a maximum segment surface with a heat contact surface is provided on a first side by using heat abstraction material, and/or on a second side heat abstraction material is provided on an insulated metal substrate, and/or for cooling a good heat transmission to the housing or its parts is produced by means of a device for generating a spring pre-tensioning and/or an elastomer element.

14. A medical or dental instrument and/or hand piece, characterised by a carrier device with a luminous diode arranged on it for emitting light in the direction of an area in the environment of the instrument or hand piece, the carrier device providing a good heat coupling to the housing of the instrument or hand piece and/or its sections for a good abstraction of heat generated by the luminous diode.

15. The instrument or hand piece according to claim 14, characterised in that the carrier device is designed in the form of an annular disc or a its segment the surface of it which carries the luminous diode extending essentially rectangular to the longitudinal extension of the housing of the instrument or the hand piece, and/or a light emitting device for driving medical or dental instruments and/or hand pieces with
a carrier device consisting of a at least one first layer and at least one second layer; and
a luminous diode arranged on a surface of the carrier device pointing in the direction of light emission; wherein
the at least one first layer of the carrier device contains a conductive layer for power supply of the luminous diode; and
the at least one second layer of the carrier device contains a heat abstraction layer for abstracting emission heat of the luminous diode,
is used.

16. The instrument or hand piece according to claim 14, characterised in that for cooling the heat abstraction generated because of the heat output of the luminous diode at the carrier device a maximum segment surface with a heat contact surface is provided on a first side by using heat abstraction material, and/or on a second side heat abstraction material is provided on an insulated metal substrate, and/or for cooling a good heat transmission to the housing of the instrument or the hand piece or its parts is produced by means of a device for generating a spring pre-tension and/or an elastomer element.

17. The instrument or hand piece according to claim 14, characterised in that the elastomer element has spring qualities, is formed preferably of a Silicon which can in particular be sterilized, and, at the same time or additionally, forms a seal toward add-on pieces such as the driving device, the instrument or hand piece or its base, center or head piece.

18. The instrument or hand piece according to claim 14, characterised in that at the elastomer element at least one medium pipe with, if necessary, internal medium lines is arranged, or can be connected with at least one medium connection, and/or at the elastomer element at least one back absorption stop device is provided on at least one liquid supply.

19. The instrument or hand piece according to claim 14, characterised in that the carrier device is arranged at the instrument or hand piece in its base, center or top area.

20. The instrument or hand piece according to claim 14, characterised in that a base area of the exchangeable instrument (hand piece 200) is provided, and in the base area energy conduction contacts are provided via which the luminous diode is supplied with energy when the instrument/hand piece is connected with a hand piece carrier or driving device.
